(19) United States
(12) Patent Application Publication
(10) Pub. No.: US 2026/0160629 A1
(43) Pub. Date: Jun. 11, 2026

(54) AUTOMATICALLY CALIBRATING PRESSURE GAUGES

(71) Applicant: Baker Hughes Holdings LLC, Houston, TX (US)

(72) Inventor: Tabajara Williams Vilela Vasconcelos, São Paulo (BR)

(21) Appl. No.: 19/406,325

(22) Filed: Dec. 2, 2025

Related U.S. Application Data
(60) Provisional application No. 63/730,273, filed on Dec. 10, 2024.

(51) Int. Cl. G01L 27/00; G01L 19/16; G06V 10/774; G06V 20/62

(52) U.S. Cl. CPC G01L 27/002; G01L 19/16; G06V 10/774; G06V 20/62

(57) ABSTRACT

A pressure source provides a specified pressure to a pressure gauge. Data characterizing an image of the pressure gauge while the pressure gauge is provided the pressure is received from a camera. Data characterizing a pressure provided to the pressure gauge is received from the pressure source. A calibration status of the pressure gauge is determine based on the data characterizing the image and the data characterizing the pressure. The calibration status is provided.

### CROSS REFERENCE TO RELATED APPLICATIONS

This application claims priority under 35 U.S.C. § 119(e) to United States Provisional Patent Application No. 63/730,273, entitled AUTOMATICALLY CALIBRATING PRESSURE GAUGES,” filed on 10 December 2024, the entirety of which is hereby incorporated by reference.

### TECHNICAL FIELD

The subject matter described herein relates to gauge calibration.

### BACKGROUND

Analogue and digital gauges, for example, pressure gauges, are often used for process monitoring in hydrocarbon production facilities. Such gauges are inspected and calibrated at regular intervals to ensure accurate readings are provided by the gauges.

### SUMMARY

This disclosure relates to automatically calibrating pressure gauges.

An example implementation of the subject matter described herein is a method with the following features. A pressure source provides a specified pressure to a pressure gauge. Data characterizing an image of the pressure gauge while the pressure gauge is provided the pressure is received from a camera. Data characterizing a pressure provided to the pressure gauge is received from the pressure source. A calibration status of the pressure gauge is determine based on the data characterizing the image and the data characterizing the pressure. The calibration status is provided.

The disclosed method can be implemented in a variety of ways. For example, within a system that includes at least one data processor and a non-transitory memory storing instructions for the processor to perform aspects of the method. Alternatively or in addition, the method can be in included non-transitory computer readable memory storing the method as instructions which, when executed by at least one data processor forming part of at least one computing system, causes the at least one data processor to perform operations of the method.

Aspects of the example method, that can be combined with the example method alone or in combination with other aspects, can include the following. A calibration on the pressure gauge is adjusted.

Aspects of the example method, that can be combined with the example method alone or in combination with other aspects, can include the following. The image is a first image, the pressure is a first pressure, and the calibration status is a first calibration status. The method further includes the following features. The specified pressure is sent to the pressure gauge by the pressure source. Data characterizing a second image of the pressure gauge is received from the camera. data characterizing a second pressure delivered to the pressure gauge is received from the pressure source. A second calibration status of the pressure gauge is determined. The second calibration status is provided.

Aspects of the example method, that can be combined with the example method alone or in combination with other aspects, can include the following. Providing the calibration status includes storing data characterizing the calibration status in a non-transitory memory training a machine learning model on the data characterizing the calibration.

Aspects of the example method, that can be combined with the example method alone or in combination with other aspects, can include the following. Determining the calibration status of the pressure gauge includes providing the data characterizing an image to a trained machine learning model.

Aspects of the example method, that can be combined with the example method alone or in combination with other aspects, can include the following. The pressure gauge is an analog pressure gauge. The data characterizing the image of the pressure gauge is pre-processed. a center of gauge and an outer circle of gauge are detected. a pressure range of the gauge is determined. a reading of the pressure gauge is determined. the determined reading is compared to the data characterizing the pressure delivered to the pressure gauge.

Aspects of the example method, that can be combined with the example method alone or in combination with other aspects, can include the following. A signal is sent to a calibrator in response to determining the calibration status of the pressure gauge. the calibrator is articulated to adjust a calibration of the pressure gauge responsive to the signal.

Aspects of the example method, that can be combined with the example method alone or in combination with other aspects, can include the following. The calibration status includes data characterizing the pressure gauge, a model number of the pressure gauge, a prior calibration date, a current calibration date, a type of pressure gauge, a range of the pressure gauge, a pass/fail status characterizing if the gauge is within specification, test data, and an amount of drift from ideal calibration state.

### BRIEF DESCRIPTION OF DRAWINGS

These and other features will be more readily understood from the following detailed description taken in conjunction with the accompanying drawings.

FIG. 1 is a flowchart of a method that can be used with aspects of this disclosure.

FIGS. 2A-2C is a pressure gauge calibration system;

FIG. 3 is a flowchart of a method that can be used with aspects of this disclosure;

FIGS. 4A-4E are illustrate steps of image processing that can be used to calibrate analog gauges;

FIG. 5A-5B are flowcharts of methods that can be used with aspects of this disclosure;

FIG. 6 is a flowchart of a method that can be used with aspects of this disclosure; and

FIG. 7 is a block diagram of an example controller that can be used with aspects of this disclosure.

### DESCRIPTION

Certain implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting implementations and that the scope of the present invention is defined solely by the claims. The features illustrated or described in connection with one implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

Certain exemplary implementations will now be described to provide an overall understanding of the principles of the structure, function, manufacture, and use of the systems, devices, and methods disclosed herein. One or more examples of these implementations are illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Current calibration process for equipment that is not configured to communicate directly with the reference calibrator (e.g. analog gauges, digital gauges, etc.) rely on human judgment to take notes of manual reading. This process generates errors related to when the person takes note of the value of the reference device and takes notes on the reading of the analog/digital device. Such a process also has opportunities for poor record keeping and the inability to audit results.

The subject matter described herein describes a pressure testing system that includes a pressure source, a camera, and a controller. The pressure source provides a specified pressure to an analog or digital pressure gauge. Data characterizing an image of the pressure gauge while the pressure gauge is provided the pressure is received from a camera. Data characterizing a pressure provided to the pressure gauge is received from the pressure source. A calibration status of the pressure gauge is determine based on the data characterizing the image and the data characterizing the pressure provided to the pressure gauge. The calibration status is provided. The calibration status can include a pass/fail result, final calibration accuracy, a calibration offset,

The disclosed method can be implemented in a variety of ways. For example, within a system that includes at least one data processor and a non-transitory memory storing instructions for the processor to perform aspects of the method. Alternatively or in addition, the method can be in included non-transitory computer readable memory storing the method as instructions which, when executed by at least one data processor forming part of at least one computing system, causes the at least one data processor to perform operations of the method.

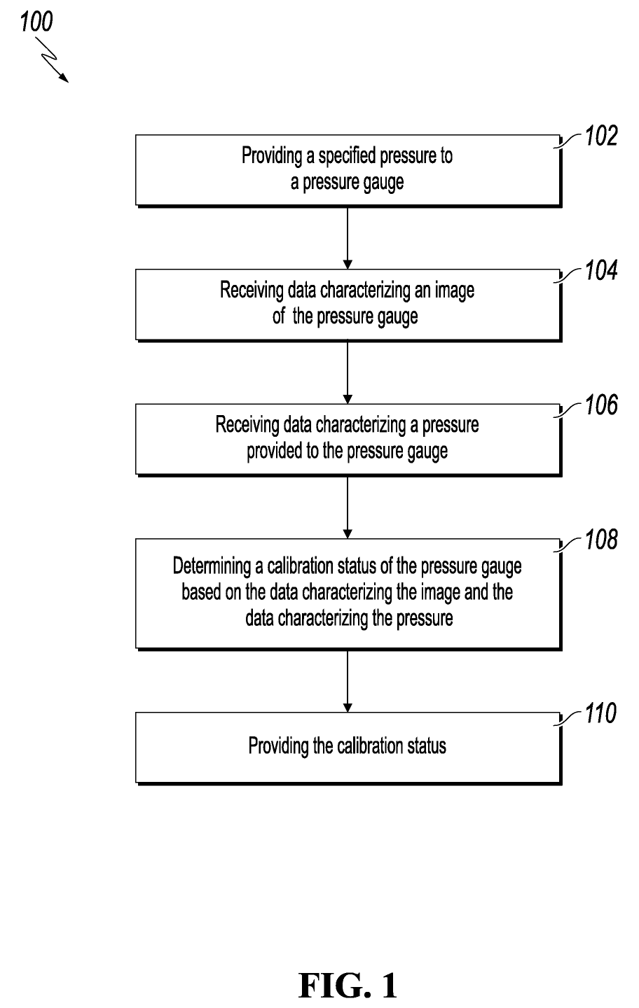

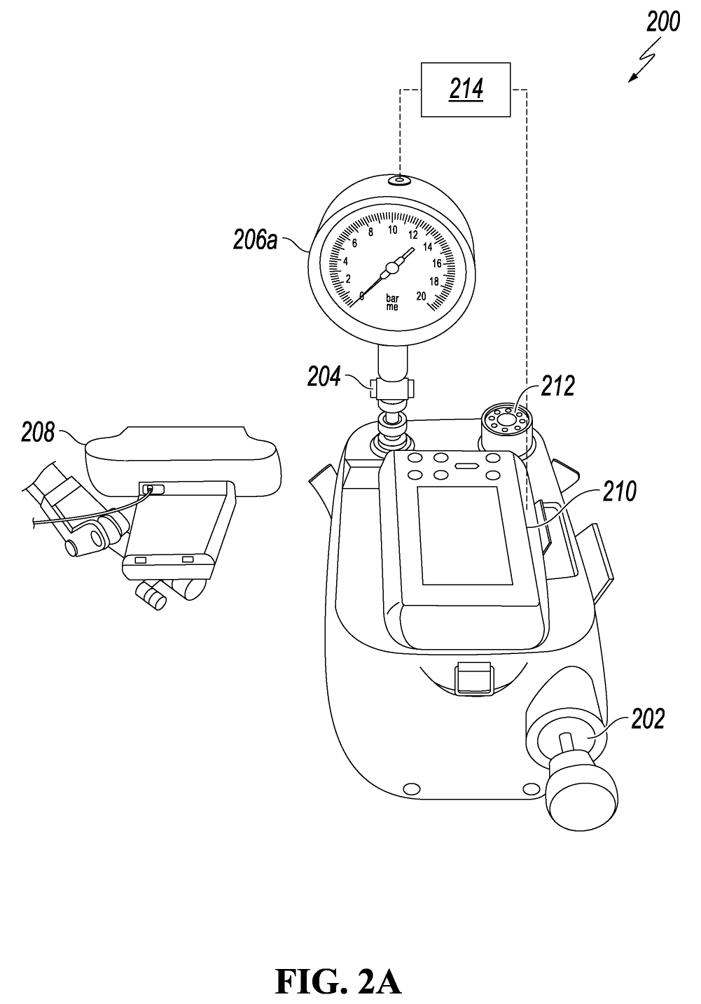

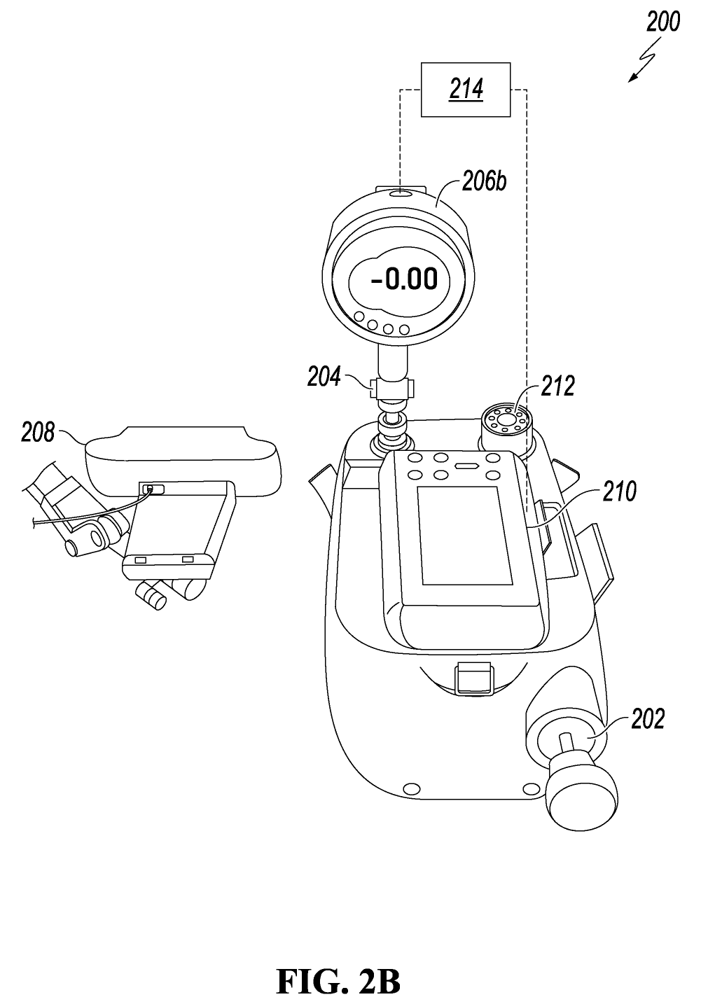

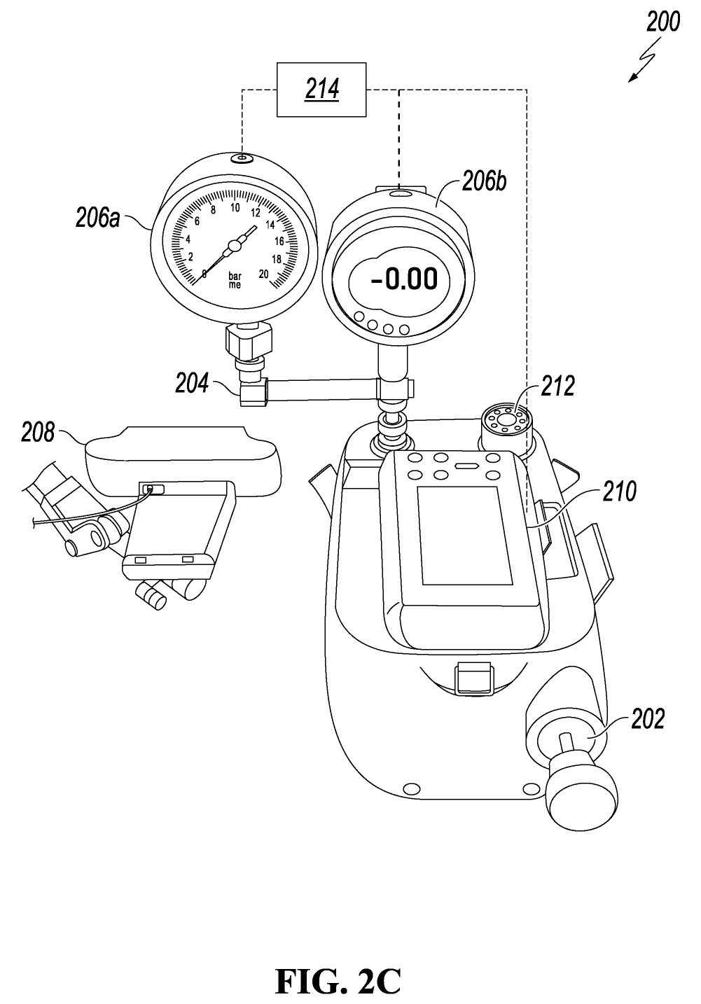

FIG. 1 is a flowchart of a method 100 that can be used with aspects of this disclosure and is described in combination with an example gauge calibration system 200 illustrated in FIGS. 2A-2C. The system 200 includes a pressure source 202 coupled to a manifold 204. The pressure source 202 is configured to, at 102, provide a specified pressure to the manifold 204 and a pressure gauge 206 fluidically coupled to the manifold 204. The pressure gauge can be an analog pressure gauge 206a, a digital pressure gauge 206b, or a combination as shown in FIG. 2C. The methods and systems described herein are applicable to both digital gauges and analog gauges. The specified pressure can, in some implementations, correspond to a testing procedure. The specified pressure is within a range readable by the pressure gauge 206 to be tested. In operation, the pressure gauge 206 to be tested is coupled to the manifold 204 to receive the specified pressure provided by the pressure source 202 by the manifold 204. The pressure source 202 itself can include a hydraulic or pneumatic pump, a piston and cylinder, a pressurized bladder, a pressurized tank with a regulator, or any other source of pressure capable of delivering the specified pressure.

A camera 208 is arranged such that the camera 208 has a clear view of the pressure gauge 206 to be tested. In operation, the camera 208 captures an image of the pressure gauge 206 while the pressure gauge 206 is being tested. That is, the image is captured by the camera 208 while the pressure is provided to the pressure gauge 206.

Both the camera 208 and the pressure source 202 are coupled to a controller 210. The controller 210 is configured to regulate the pressure of the pressure source 202, direct the camera 208 to capture an image, and is configured to, at 104, receive data characterizing the image as well as, at 106, receive data characterizing pressure provided to the pressure gauge, for example, from a transducer or other pressure sensor 212 fluidically coupled to the pressure source 202 or manifold 204. More details on the controller 210 are described throughout this disclosure. At 108, a calibration status of the pressure gauge 206 is determined, for example, by the controller 210, based on the data characterizing the image and the data characterizing the pressure. Then, at 110, the calibration status can be provided, for example, by the controller 210.

The calibration status can include data characterizing the pressure gauge including model number, prior calibration date, current calibration date, type of gauge, gauge range, a pass/fail status characterizing if the gauge is within specification, test data, and an amount of drift from ideal calibration state. Other information can be included withing the calibration status without departing from this disclosure.

In some implementations, a calibrator 214 is coupled to the controller and is configured to be coupled to the pressure gauge 206, for example a set screw of the pressure gauge 206a or a command to zero, for example, by a button, for the pressure gauge 206b. The calibrator 214 is configured to adjust a calibration set point of the pressure gauge 206. In such implementations, during operation, the controller 210 sends a signal to the calibrator 214 in response to determining the calibration status of the pressure gauge 206. The signal is configured to articulate the calibrator 214 to adjust the calibration set point of the pressure gauge 206.

In instances where the pressure gauge 206 is not within specification, the pressure gauge 206 is adjusted and retested, for example, by the calibrator 214 or a technician. That is, the specified pressure is again provided to the pressure gauge 206 by the pressure source 202. The camera 208 takes a second image of the pressure gauge while the pressure is provided and sends data characterizing the second image of the pressure gauge 206 to the controller 210. The data characterizing the second image and data characterizing the specified pressure is received by the controller 210, which then determines and provides a second, update calibration status of the gauge. This process is repeated until the pressure gauge 206 is calibrated within specification.

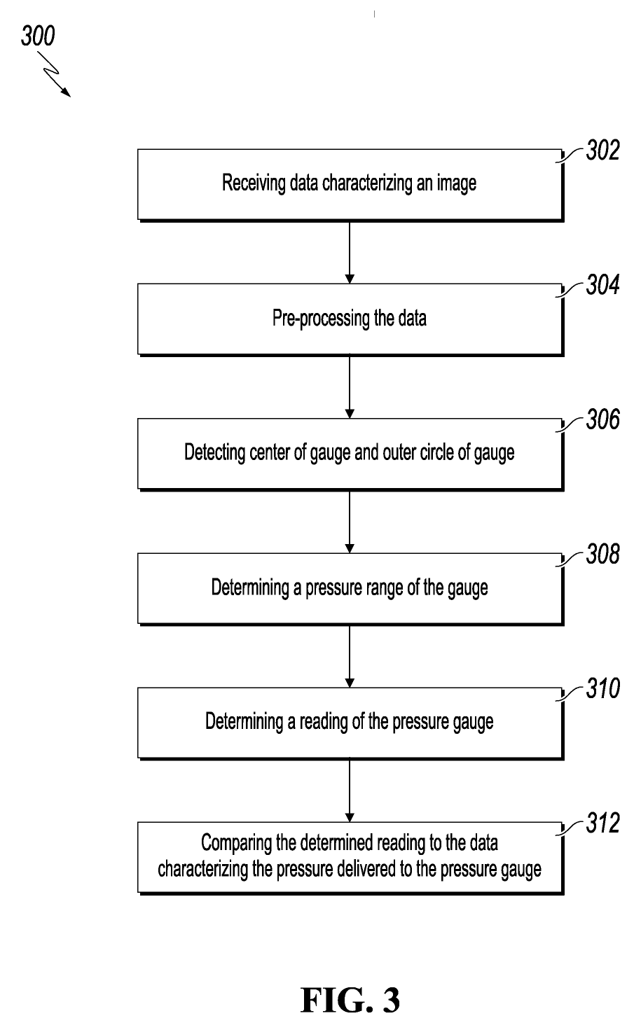

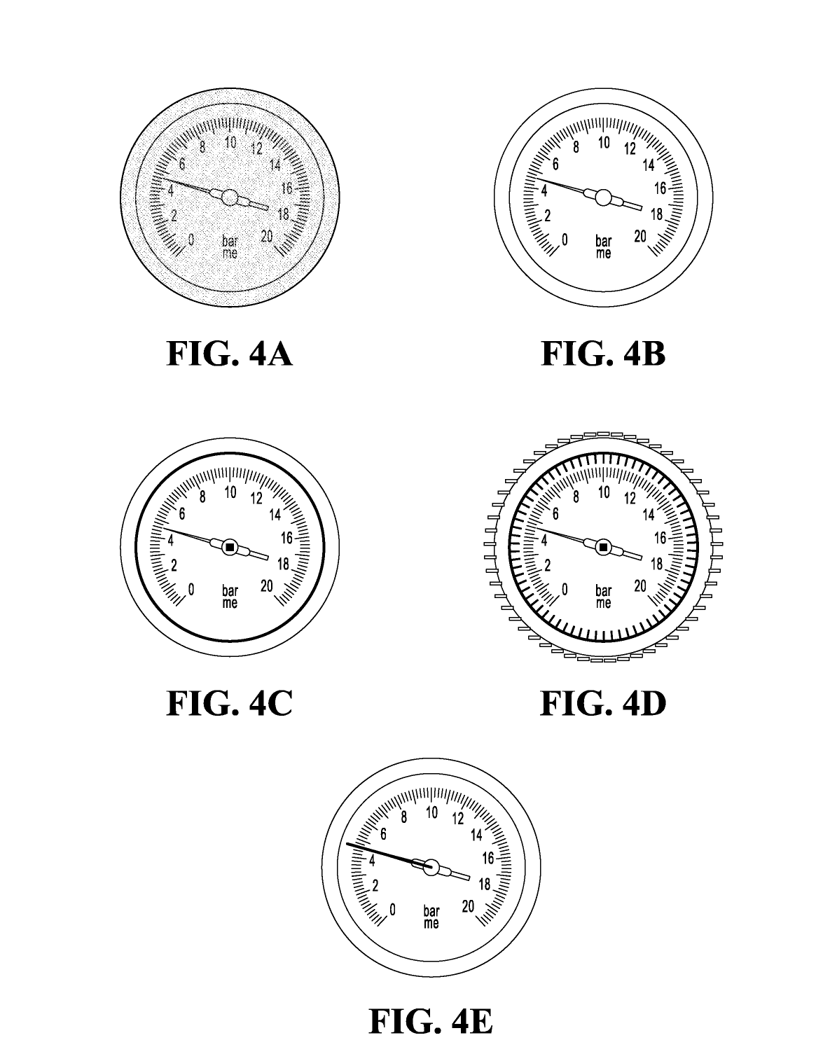

In some implementations, the data characterizing the image of the pressure gauge 206 is processed in order to make a determination of the calibration status. FIG. 3 is a flowchart of a method 300 that can be used for such processing. FIGS. 4A-4E are illustrate steps of image processing described in the method 300. At 302, data characterizing the raw image, shown in FIG. 4A, is received and, at 304, the data characterizing the image of the pressure gauge 206 is pre-processed to produce the pre-processed image shown in FIG. 4B. Preprocessing can include converting the image to a high-contrast and/or greyscale image. Using the pre-processed image of FIG. 4B, at 306, a center of the gauge and an outer circle of the gauge are detected within the preprocessed image, shown in FIG. 4C. Such detection can be accomplished using, for example, a Hough Transform, a Hough-Gradient method, a Circle Hough Transform, or another known detection algorithm appropriate for detecting such features. At 308, a pressure range of the pressure gauge 206 is determined, and the indices are marked and graduated as shown in FIG. 4D. That is, the controller determines a location and value of indices within the image of the pressure gauge 206. At 310, a reading of the pressure gauge is determined, for example, by identifying a position of a gauge needle of the pressure gauge 206 as illustrated in FIG. 4E. At 312, the determined reading is compared to the data characterizing the pressure delivered to the pressure gauge 206. The comparison is used to help determine the calibration status of the pressure gauge 206. For example, pressure delivered to the pressure gauge 206 is different from the gauge reading by more than a specified percentage can be an indication that the pressure gauge 206 needs recalibration. The steps described in FIGS. 4A-4E are substantially similar in implementations that use a digital pressure gauge. In such instances, optical character recognition can be used, for example after preprocessing data characterizing a raw image of the digital pressure gauge, for example, converting the image to a high-contrast and/or greyscale image.

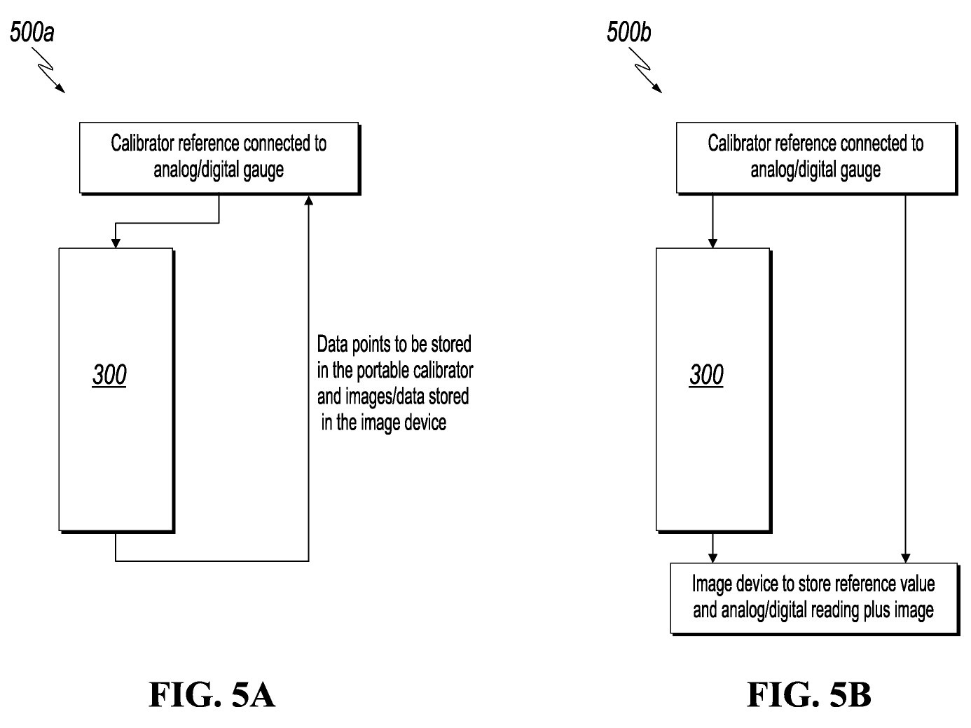

The calibration status, data characterizing the pressure delivered to the pressure gauge, the data characterizing the image of the pressure gauge, and/ other data used in method 300 can be stored in a variety of places. For example, as shown in FIG. 5A, the data can be stored in the calibration system, for example, within non-transitory memory of the controller 210. Alternatively or in addition, as shown in FIG. 5B, the data can be stored within non-transitory memory of the camera 208.

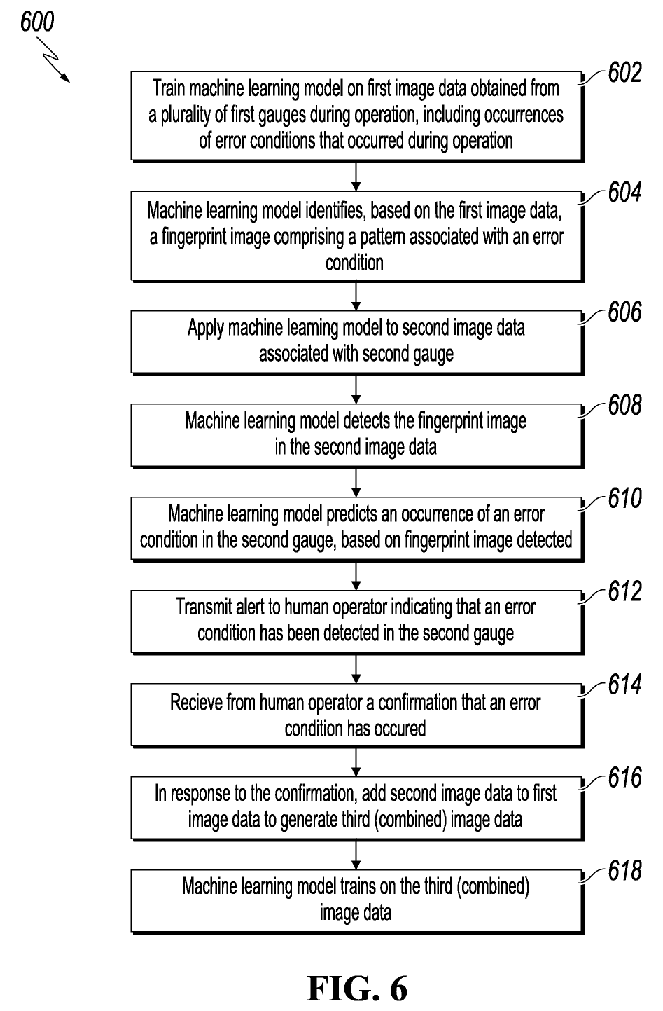

Alternatively or in addition, providing the calibration status can include training a machine learning model on the data characterizing the calibration. Such a method 600 is illustrated in FIG. 6. At 602, a machine learning model is trained on data characterizing a calibration status and images of multiple pressure gauges. Some of the training data may include instances where one or more of the pressure gauges were out of calibration. At 604, the machine learning model identifies a pattern associated with error conditions, such as a pressure gauge being out of calibration. At 606, data characterizing a new image of a new gauge and data characterizing a specified pressure is provided to the machine learning model. In some instances, such as at 608, the machine learning model identifies characteristics within the data indicative of an error or other indication of miscalibration. Alternatively, in instances where the gauge is in calibration, the machine learning model can identify characteristics within the data indicative that the gauge passes inspection. At 610, the machine learning model predicts that the gauge is out of calibration based on the error or other indication of miscalibration. At 612, an alert can be sent to a technician that an error has been detected in the new pressure gauge. At 614, the technician can confirm the error or miscalibration. In response to the confirmation provided by the technician, at 616, the machine learning model classifies and stores the data as an example of an error or miscalibration. At 618, the machine learning model trains on the new example of an error or miscalibration.

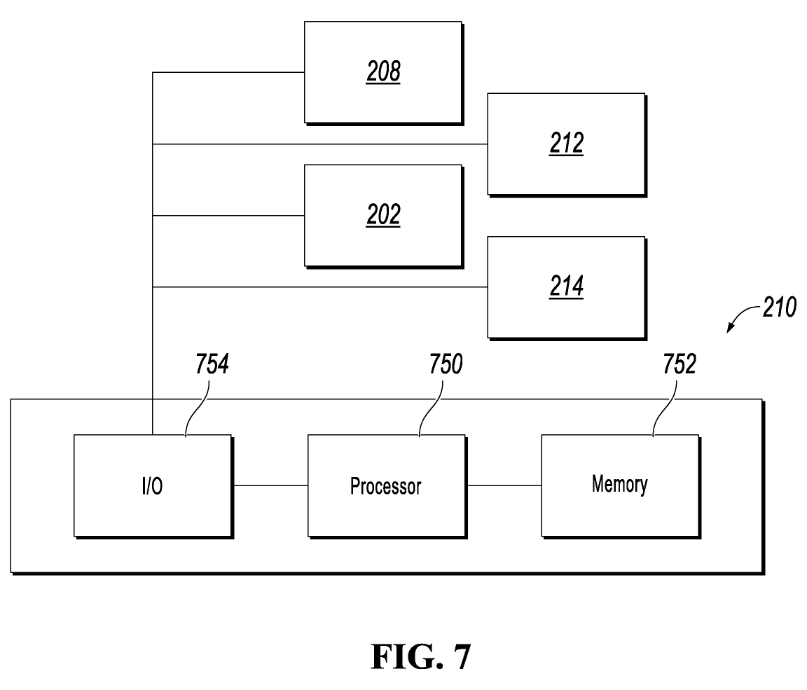

FIG. 7 illustrates an example controller 210 that can be used with some aspects of the current subject matter. The controller 210 can, among other things, monitor parameters of the system 200 send signals to actuate and/or adjust various operating parameters of such systems. As shown in FIG. 7, the controller 210 can include one or more processors 750 and non-transitory computer readable memory storage (e.g., memory 752) containing instructions that cause the processors 750 to perform operations. The processors 750 are coupled to an input/output (I/O) interface 754 for sending and receiving communications with components in the system, including, for example, the camera 208 or the pressure sensor 212. In certain instances, the controller 210 can additionally communicate status with and send actuation and/or control signals to one or more of the various system components (including, for example, the pressure source 202 and/or the calibrator 214) of the system 200, as well as other sensors (e.g., pressure sensors, temperature sensors, vibration sensors and other types of sensors) that provide signals to the system 200.

The controller 210 can be implemented with various levels of autonomy. In some implementations, the controller 210 alerts the technician that the pressure gauge 206 is out of specification/calibration, for example, a difference between the delivered pressure and the read pressure being beyond a specified threshold, and the operator then adjusts the pressure gauge 206 to read within the specified threshold. In some implementations, the controller 210 alerts the technician that the pressure gauge is out of specification and provides recommendations to the technician to move the parameter within specification. The operator then selects an option and the controller adjusts operations accordingly, for example, by directing the calibrator to adjust the pressure gauge. In some instances, the controller 210 determines that a parameter is out of specification, and changes or otherwise adjusts operations to move the parameter within specification with no input from the operator, for example, by directing the calibrator to adjust the pressure gauge.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

1. A method comprising:
providing, by a pressure source, a specified pressure to a pressure gauge;
receiving, from a camera, data characterizing an image of the pressure gauge while the pressure gauge is provided the pressure;
receiving, from the pressure source, data characterizing a pressure provided to the pressure gauge;
determining a calibration status of the pressure gauge based on the data characterizing the image and the data characterizing the pressure; and
providing the calibration status.

2. The method of claim 1, further comprising adjusting a calibration on the pressure gauge.

3. The method of claim 2, wherein the image is a first image, the pressure is a first pressure, and the calibration status is a first calibration status, the method further comprising:
sending, by a pressure source, the specified pressure to the pressure gauge;
receiving, from a camera, data characterizing a second image of the pressure gauge;
receiving, from the pressure source, data characterizing a second pressure delivered to the pressure gauge;
determining a second calibration status of the pressure gauge; and
providing the second calibration status.

4. The method of claim 1, wherein providing the calibration status comprises:
storing data characterizing the calibration status in a non-transitory memory; or
training a machine learning model on the data characterizing the calibration.

5. The method of claim 1, wherein determining the calibration status of the pressure gauge comprises:
providing the data characterizing an image to a trained machine learning model.

6. The method of claim 1, wherein the pressure gauge is an analog pressure gauge, the method further comprising:
pre-processing the data characterizing the image of the pressure gauge;
detecting center of gauge and outer circle of gauge;
determining a pressure range of the gauge;
determining a reading of the pressure gauge; and
comparing the determined reading to the data characterizing the pressure delivered to the pressure gauge.

7. The method of claim 1, further comprising:
sending a signal to a calibrator in response to determining the calibration status of the pressure gauge; and
articulating the calibrator to adjust a calibration of the pressure gauge responsive to the signal.

8. A system comprising:
a pressure source;
a camera; and
a controller comprising:
at least one data processor; and
non-transitory memory storing instructions, which, when executed by the at least one data processor causes the at least one data processor to perform operations comprising:
providing, by the pressure source, a specified pressure to a pressure gauge;
receiving, from a camera, data characterizing an image of the pressure gauge while the pressure gauge is provided the pressure;
receiving, from the pressure source, data characterizing a pressure provided to the pressure gauge;
determining a calibration status of the pressure gauge based on the data characterizing the image and the data characterizing the pressure; and
providing the calibration status.

9. The system of claim 8, further comprising a calibrator coupled to the controller and configured to be coupled to the pressure gauge, the calibrator configured to adjust a pressure gauge, the operations further comprising:
sending a signal to the calibrator in response to determining the calibration status of the pressure gauge, the signal configured to articulate the calibrator to adjust a calibration of the pressure gauge.

10. The system of claim 9, wherein the image is a first image, the pressure is a first pressure, and the calibration status is a first calibration status, the operations further comprising:
sending, by a pressure source, the specified pressure to a pressure gauge;
receiving, from a camera, data characterizing a second image of the pressure gauge;
receiving, from the pressure source, data characterizing a second pressure delivered to the pressure gauge;
determining a second calibration status of the pressure gauge; and
providing the second calibration status.

11. The system of claim 8, wherein providing the calibration status comprises:
storing data characterizing the calibration status in a non-transitory memory; or
training a machine learning model on the data characterizing the calibration.

12. The system of claim 8, wherein determining the calibration status of the pressure gauge comprises:
providing the data characterizing an image to a trained machine learning model.

13. The system of claim 8, wherein the pressure gauge is an analog pressure gauge, wherein the operations further comprise:
pre-processing the data characterizing the image of the pressure gauge;
detecting center of gauge and outer circle of gauge;
determining a pressure range of the gauge;
determining a reading of the pressure gauge; and
comparing the determined reading to the data characterizing the pressure delivered to the pressure gauge.

14. A non-transitory computer readable memory storing instructions which, when executed by at least one data processor forming part of at least one computing system, causes the at least one data processor to perform operations comprising:
receiving, from a camera, data characterizing an image of a pressure gauge;
receiving, from a pressure source, data characterizing a pressure delivered to the pressure gauge while the pressure gauge is provided the pressure;
determining a calibration status of the pressure gauge based on the data characterizing the image and the data characterizing the pressure; and
providing the calibration status.

15. The non-transitory computer readable memory of claim 14, wherein the image is a first image, the pressure is a first pressure, and the calibration status is a first calibration status, the operations further comprising:
receiving, from a camera, data characterizing a second image of the pressure gauge;
receiving, from the pressure source, data characterizing a second pressure delivered to the pressure gauge;
determining a second calibration status of the pressure gauge; and
providing the second calibration status.

16. The non-transitory computer readable memory of claim 14, wherein providing the calibration status comprises:
storing data characterizing the calibration status in a non-transitory memory; or
training a machine learning model on the data characterizing the calibration.

17. The non-transitory computer readable memory of claim 14, wherein determining the calibration status of the pressure gauge comprises:
providing the data characterizing an image to a trained machine learning model.

18. The non-transitory computer readable memory of claim 14, wherein the pressure gauge is an analog pressure gauge, wherein the operations further comprise:
pre-processing the data characterizing the image of the pressure gauge;
detecting center of gauge and outer circle of gauge;
determining a pressure range of the gauge;
determining a reading of the pressure gauge; and
comparing the determined reading to the data characterizing the pressure delivered to the pressure gauge.

19. The non-transitory computer readable memory of claim 14, wherein the operations further comprise:
sending a signal to a calibrator in response to determining the calibration status of the pressure gauge; and
articulating the calibrator to adjust a calibration of the pressure gauge responsive to the signal.

20. The non-transitory computer readable memory of claim 14, wherein the calibration status comprises:
data characterizing the pressure gauge;
a model number of the pressure gauge;
a prior calibration date;
a current calibration date;
a type of pressure gauge;
a range of the pressure gauge;
a pass/fail status characterizing if the gauge is within specification;
test data; or
an amount of drift from ideal calibration state.
